(19) United States
(12) Patent Application Publication
(10) Pub. No.: US 2026/0109795 A1
(43) Pub. Date: Apr. 23, 2026

(54) HIGH REFRACTIVE INDEX POLYVINYL ACETAL RESINS MODIFIED WITH CYCLIC ALDEHYDES

(71) Applicant: Eastman Chemical Company, Kingsport, TN (US)

(72) Inventors: Jun Lu, Greeneville, TN (US); Vinita Shinde, Kingsport, TN (US); Wenjie Chen, Amherst, MA (US); John Joseph D'Errico, Glastonbury, CT (US); Bruce Edward Wade, Madison, AL (US)

(73) Assignee: Eastman Chemical Company, Kingsport, TN (US)

(21) Appl. No.: 19/117,656

(22) PCT Filed: Oct. 3, 2023
(86) PCT No.: PCT/US2023/075781

§ 371 Date: Apr. 2, 2025

Related U.S. Application Data
(60) Provisional application No. 63/378,253, filed on Oct. 4, 2022.

(51) Int. Cl. C08F 216/06; C08F 8/12; C08F 8/28; C08F 8/48

(52) U.S. Cl. CPC C08F 216/06; C08F 8/12; C08F 8/28; C08F 8/48

(57) ABSTRACT

A modified polyvinyl acetal resin comprising residues of a cyclic aldehyde is provided for use in forming interlayers for making laminated glass. Interlayers as described herein exhibit desirable optical and acoustic properties and are more easily recycled than those without the modified polyvinyl acetal resin.

### BACKGROUND

Safety glass used in automobile windshields and architectural applications may include two sheets of glass laminated together with a plasticized polymer interlayer positioned between the glass. Polyvinyl butyral (“PVB”) can be the main component in the polymer interlayer. Typically, the PVB interlayer may be a monolayer structure, but in recent years, the volume of multi-layer polyvinyl butyral interlayers for laminated glass has been sold to the market has been growing. Multi-layer interlayers can provide enhanced sound insulation by the presence of a softer “core” layer located between two stiffer “skin” layers. Typically, the PVB resin in the core layer has a different content composition than the PVB compound in the skin layers and may, for example, have different residual hydroxyl and/or acetyl contents.

During production of monolithic interlayers, it is common for off-grade and/or trim material to be re-used in the sheet manufacturing process, since the monolithic interlayer includes only one type of polyvinyl butyral. However, because of the differences in polyvinyl butyral composition between the skin and core layers of multilayer PVB interlayers, multilayer film scrap cannot be re-extruded. When it is, the resulting blended resin composition exhibits high levels of haze, results in a final interlayer product of unacceptable visual quality. As a result, large scale recycling of multilayer interlayer material has not been successfully achieved.

Thus, it would be desirable to have a commercial-scale process and system for recycling multi-layer polyvinyl butyral scrap (e.g., from off-grade finished products, trim from the manufacturing process, and even discarded laminated glass) in both an economically and ecologically beneficial way. There is a need for resin compositions, including PVB resin compositions, that can be used in multilayer interlayers that do not exhibit haze when being re-extruded and are, as a result, more recyclable.

### SUMMARY

In one aspect, the present technology concerns a polyvinyl acetal resin composition comprising: a polyvinyl acetal resin component comprising residues of at least one cyclic aldehyde having an unsaturated 5-member or 6-member ring group and another polyvinyl acetal resin component comprising residues of at least one C3 to C8 aliphatic aldehyde; and at least one plasticizer.

In one aspect, the present technology concerns a polyvinyl acetal resin composition comprising: one or more polyvinyl acetal resins, wherein the polyvinyl acetal resins comprise at least one polyvinyl acetal resin component that includes residues of at least one cyclic aldehyde comprising at least one heterocyclic ring group; and at least one plasticizer, wherein the composition comprises less than 5 weight percent of resins other than the polyvinyl acetal resins.

In one aspect, the present technology concerns an interlayer comprising: a first resin layer comprising a first polyvinyl acetal resin and at least one plasticizer; and a second resin layer comprising a polyvinyl acetal resin component comprising residues of at least one cyclic aldehyde, another polyvinyl acetal resin component comprising residues of at least one C3 to C8 aliphatic aldehyde, and at least one plasticizer, wherein the cyclic aldehyde comprises (a) a conjugated 5-member or 6-member ring and/or (b) a heterocyclic ring.

In one aspect, the present technology concerns a method of making a polyvinyl acetal resin component, said method comprising at least one of the following steps (a) and (b): (a) acetalizing polyvinyl alcohol with at least one C3 to C8 aliphatic aldehyde and at least one cyclic aldehyde to form a modified polyvinyl acetal resin, wherein the cyclic aldehyde comprises (i) an unsaturated 5-member or 6-member ring and/or (ii) a heterocyclic ring; and/or (b) blending a polyvinyl acetal resin comprising residues of a cyclic aldehyde and/or a heterocyclic ring with another polyvinyl acetal resin comprising at least 50 weight percent of residues of a C3 to C8 aliphatic aldehyde to form a blended polyvinyl acetal resin composition.

In one aspect, the present technology concerns a blended polyvinyl acetal resin composition comprising: a first polyvinyl acetal resin having a residual hydroxyl content of at least 16 weight percent; a polyvinyl acetal resin component having residues of at least one cyclic aldehyde, wherein the cyclic aldehyde comprises (a) an unsaturated 5-member or 6-member ring and/or (b) a heterocyclic ring; and at least one plasticizer, wherein the resin composition has a haze value of less than 1.

### BRIEF DESCRIPTION OF THE DRAWINGS

Various embodiments of the present technology are described in detail below with reference to the attached drawing Figures, wherein:

FIG. 1 is a block flow diagram illustrating the main steps/zones of a process/facility for producing a modified polyvinyl acetal resin according to embodiments of the present technology; and

FIG. 2 is a cross-section of a multilayer interlayer according to embodiments of the present technology.

### DETAILED DESCRIPTION

We have discovered a polyvinyl acetal resin composition suitable for use in forming interlayers suitable for use in various applications which can also be recycled in larger quantities. In particular, we have found that multilayer interlayers having a core resin layer with a higher refractive index can exhibit lower haze values when blended with other polyvinyl acetal resins, such as those used to form skin layers. As a result, such multilayer interlayers can be recycled by, for example, combining multilayer scrap with skin layer resin and re-extruding the combination to form recycled interlayers. The novel polyvinyl acetal resins used for the core layer comprise cyclic aldehyde side groups extending from the polymer backbone. The modified polyvinyl acetal resin can be formed by co-acetalizing at least one cyclic aldehyde with at least one C3 to C8 aliphatic aldehyde, and the resulting modified polyvinyl acetal resin can be blended with at least one plasticizer to form a modified resin composition suitable for use in multilayer interlayers.

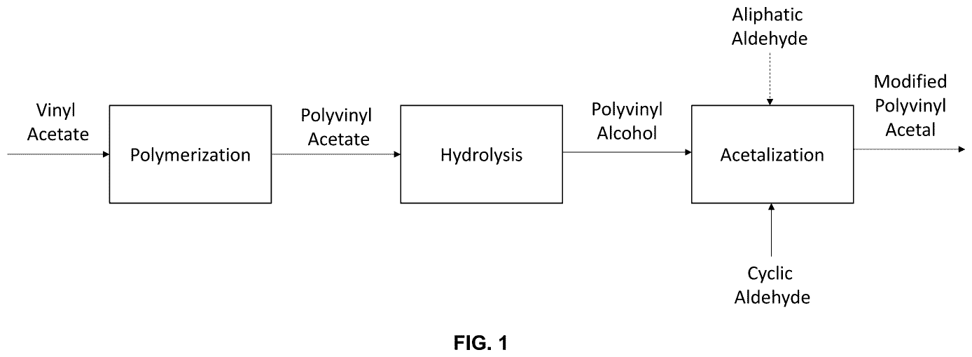

Turning initially to FIG. 1, a block flow diagram illustrating the main steps/zone of a process/facility for forming a modified polyvinyl acetal resin according to embodiments of the present technology is provided. As shown in FIG. 1, vinyl acetate may be polymerized to provide polyvinyl acetate, which can then be hydrolyzed to provide a polyvinyl alcohol. At least a portion of the polyvinyl alcohol can then be reacted with at least one cyclic aldehyde to form a modified polyvinyl acetal resin. The acetalization reaction can be performed in the presence of a catalyst, which can be an acid or a base, via suspension or solution polymerization. The resulting modified polyvinyl acetal resin can then be separated, stabilized, and dried according to known methods such as, for example, those described in U.S. Pat. Nos. 2,282,057 and 2,282,026, as well as Wade, B. 2016, Vinyl Acetal Polymers, Encyclopedia of Polymer Science and Technology. 1-22 (online, copyright 2016 John Wiley & Sons, Inc.).

When used herein, the term “modified polyvinyl acetal resin” refers to a polyvinyl acetal resin including residues of at least one cyclic aldehyde. The modified polyvinyl acetal resin may have a total percent acetalization of at least 50, at least 55, at least 60, at least 65, at least 70, at least 75, at least 80, at least 85, at least 90 weight percent, measured according to ASTM D-1396, unless otherwise noted. The total amount of aldehyde residues in a polyvinyl acetal resin can be collectively referred to as the acetal component, with the balance of the polyvinyl acetal resin being residual vinyl alcohol (hydroxyl) groups and residual acetate (acetyl) groups, which will be discussed in further detail below. As used herein, the term “unmodified polyvinyl acetal resin,” refers to a polyvinyl acetal resin that does not include residues of a cyclic vinyl acetal monomer and comprises at least 99 weight percent of residues of vinyl acetate, polyvinyl alcohol, and at least one aldehyde.

The modified polyvinyl acetal resin may comprise at least 1, at least 2, at least 5, at least 10, at least 15, or at least 20 weight percent and/or not more than 50, not more than 45, not more than 40, not more than 35, not more than 30, not more than 25, or not more than 20 weight percent of residues of one or more cyclic aldehydes, based on the total moles of aldehyde residues in the polyvinyl acetal resin. Alternatively, the modified polyvinyl acetal resin may comprise at least 45, at least 50, at least 55, at least 60, at least 65, at least 70, at least 75, at least 80, at least 85, at least 90, at least 95, or at least 99, or up to 100 weight percent and/or not more than 99, not more than 95, not more than 90, not more than 85, not more than 80, not more than 75, not more than 70, not more than 65, not more than 60, not more than 55, or not more than 50 weight percent of residues of the cyclic aldehyde, based on the total weight of aldehyde residues in the modified polyvinyl acetal resin.

The cyclic aldehyde can comprise at least one, two, or three ring groups. One or more ring groups may individually include at least 5, at least 6, at least 8, or at least 10 atoms and/or not more than 30, not more than 28, not more than 24, not more than 22, not more than 20, not more than 18, not more than 16, not more than 14, not more than 12, not more than 10, not more than 8, not more than 6, not more than 5, nor more than 4, or not more than 3 carbon atoms per ring. In some cases, the ring may include only carbon atoms. At least one of the ring groups can be unsaturated and, in some cases, it may be conjugated or even aromatic. In some cases, the cyclic aldehyde can include at least one unsaturated 5-member or 6-member ring group.

In some embodiments, the cyclic aldehyde can include a heterocyclic ring having at least one atom other than carbon in the main ring structure. When heterocyclic, the ring group can comprise at least one heteroatom selected from the group consisting of sulfur(S), phosphorous (P), nitrogen (N), and oxygen (O). In some cases, the heterocyclic ring can be unsaturated, while in others it may be conjugated. The heterocyclic ring may be saturated. The cyclic aldehyde may include one or more heterocyclic rings.

Examples of specific cyclic aldehydes suitable for use in embodiments of the present technology can include, but are not limited to, hydroxymethyl furfural 2-furfural, substituted furfural, (HMF), thiophenecarboxaldehyde, 3-thiophenecarboxaldehyde, 2-pyridinecarboxyaldehyde, 2-acetylthiophene, 2-pyrrole-2-carboxaldehyde, 5-bromo-2-thiophenecarboxyaldehyde, benzo(b)thiophene-2-carboxaldehyde, 4-pyridinecarboxaldehyde, and 3-pyridinecarboxaldehyde. In some embodiments, the cyclic aldehyde may not be furfural or derivatives thereof.

The cyclic aldehyde can have a refractive index of at least 1.500, at least 1.505, at least 1.510, at least 1.515, at least 1.520, at least 1.525, at least 1.530, at least 1.535, at least 1.540, at least 1.545, at least 1.550, at least 1.555, at least 1.560, at least 1.565, at least 1.570, at least 1.575, at least 1.580, at least 1.585, at least 1.590, at least 1.595, at least 1.600, at least 1.605, at least 1.610, at least 1.615, at least 1.620, at least 1.625, at least 1.630, at least 1.635, at least 1.640, at least 1.645, at least 1.650, at least 1.655, at least 1.660, at least 1.665, at least 1.670, or at least 1.675 and/or not more than 2.000, not more than 1.950, not more than 1.900, not more than 1.850, not more than 1.800, not more than 1.750, not more than 1.700, not more than 1.650, not more than 1.600, not more than 1.590, not more than 1.580, not more than 1.575, not more than 1.570, not more than 1.565, not more than 1.560, not more than 1.555, not more than 1.550, not more than 1.545, not more than 1.540, not more than 1.535, not more than 1.530, or not more than 1.525.

In some embodiments, the modified polyvinyl acetal resin can additionally include residues of at least one C1 to C10 aliphatic aldehyde, a C3 to C8 aliphatic aldehyde, a C3 to C6 aliphatic aldehyde, or a C4 aliphatic aldehyde. Examples of suitable aldehydes can include, but are not limited to, n-butyraldehyde, iso-butyraldehyde, 2-methylvaleraldehyde, n-hexyl aldehyde, 2-ethylhexyl aldehyde, n-octyl aldehyde, and combinations thereof. The modified polyvinyl acetal resin can include at least 50, at least 55, at least 60, at least 65, at least 70, at least 75, at least 80, at least 85, at least 90, or at least 95 weight percent or in the range of from 20 to 90, from 30 to 80, or from 40 to 70 weight percent of residues of one or more C3 to C8 aliphatic aldehydes, based on the total weight of aldehyde residues in the polyvinyl acetal resin. Alternatively, the modified polyvinyl acetal resin can include less than 50, less than 45, less than 40, less than 35, less than 30, less than 25, less than 20, less than 15, less than 10, less than 5, less than 2, less than 1, or less than 0.5 weight percent of residues of one or more C3 to C8 aliphatic aldehydes, based on the total weight of aldehyde residues in the polyvinyl acetal resin. In some cases, the modified polyvinyl acetal resin may include no residues of a C3 to C8 aliphatic aldehyde.

Although generally described herein with respect to a single polyvinyl acetal resin with residues (or moieties) of two or more aldehydes, it should be understood that, in some cases, an equivalent physical blend of two polyvinyl acetal resins each including residues of one of the aldehydes would provide similar results as a single modified polyvinyl acetal resin. As used herein, the term “polyvinyl acetal resin component” can refer to an individual polyvinyl acetal resin present in a physical blend of two or more resins or to an acetal moiety present on a single polyvinyl acetal resin.

In some cases, at least one resin composition, layer, or interlayer described herein can include a polyvinyl acetal resin component including a residues of a cyclic aldehyde and another polyvinyl acetal resin component that does not include residues of a cyclic aldehyde (and may, for example, include residues of a C3 to C8 aliphatic aldehyde). This polyvinyl acetal resin component can refer to (1) a blend of two different polyvinyl acetal resins (e.g., one with cyclic aldehyde residues and one without) or to (2) a single polyvinyl acetal resin having two different acetal moieties (e.g., one with cyclic aldehyde residues and one without). In either case, the polyvinyl acetal resin component (as a single polyvinyl acetal resin or as a blend of two or more resins) may be combined with one or more plasticizers and optionally other additives, to provide a single plasticized composition, layer, or interlayer according to embodiments of the present technology. As discussed above, the polyvinyl acetal resin including residues of the cyclic aldehyde can be referred to as the “modified polyvinyl acetal resin,” whether or not it includes residues of another aldehyde (e.g., a C3 to C8 aliphatic aldehyde). When blended, the polyvinyl acetal resin with residues of another aldehyde can have similar properties as the modified polyvinyl acetal resin (e.g., hydroxyl content, acetate content, etc.) present in the blend.

When forming a modified polyvinyl acetal resin that includes residues (or moieties) of both a cyclic aldehyde and another aldehyde (e.g., the C3 to C8 aliphatic aldehyde), the cyclic aldehyde and the other aldehyde (e.g., the C3 to C8 aliphatic aldehyde) may be combined prior to being introduced into the acetalization step/zone (not shown in FIG. 1), or the aldehydes may be added separately as shown in FIG. 1. When added separately, the aldehydes can be added simultaneously or sequentially. For example, in some cases, the C3 to C8 aliphatic aldehyde may be added after the cyclic aldehyde has been added and at least partially reacted with the polyvinyl alcohol. When the modified polyvinyl acetal resin only includes residues of the cyclic aldehyde, it may be added to the reaction at any suitable time, and no C3 to C8 aldehyde may be added.

The modified polyvinyl acetal resin can have a residual hydroxyl content of at least 8, at least 8.5, at least 9, at least 9.5, at least 10, at least 10.5, at least 11, at least 11.5, at least 12, or at least 12.5 weight percent and/or not more than 16, not more than 15.5, not more than 15, not more than 14.5, not more than 14, not more than 13.5, not more than 13, not more than 12.5, or not more than 12 weight percent. Additionally, or alternatively, the modified polyvinyl acetal resin can have a residual acetate content of at least 0.5, at least 1, at least 1.5, at least 2, at least 5, at least 10, at least 15, or at least 18 weight percent and/or not more than 35, not more than 30, not more than 25, not more than 20, not more than 15, not more than 10, not more than 8, not more than 6, not more than 5, not more than 3, not more than 2.5, or not more than 2 weight percent.

As used herein, the terms “residual hydroxyl content” and “residual acetate content” refer to the amount of hydroxyl and acetate groups, respectively, that remain on a polyvinyl resin after the acetalization reaction is complete. In the process of hydrolyzing the polyvinyl acetate, not all of the acetate groups are converted to hydroxyl groups, and residual acetate groups remain on the resin. Similarly, in the process of acetalizing the polyvinyl alcohol, not all of the hydroxyl groups are converted to acetal groups, which also leaves residual hydroxyl groups on the resin. As a result, most polyvinyl acetal resins include both residual hydroxyl groups (as vinyl hydroxyl groups) and residual acetate groups (as vinyl acetate groups) as part of the polymer chain. The residual hydroxyl content and residual acetate content are expressed in weight percent, based on the weight of the polymer resin, and are measured according to ASTM D-1396, unless otherwise noted.

In some embodiments, the modified polyvinyl acetal resin can comprise less than 5, less than 3, less than 2, less than 1, or less than 0.5 weight percent of residues other than residual hydroxyl groups, residual acetate groups, and residues of aldehydes in the polymer backbone. For example, the modified polyvinyl acetal resin may include less than 5, less than 3, less than 2, less than 1, or less than 0.5 weight percent of residues of acrylic resins, butadiene, imides, and combinations thereof.

The modified polyvinyl acetal resin can have a molecular weight of at least 30,000, at least 50,000, at least 70,000, at least 100,000, at least 250,000, at least 500,000 Daltons and/or not more than 1,000,000, not more than 750,000, not more than 600,000, not more than 550,000, not more than 500,000, not more than 450,000, or not more than 425,000 Daltons, measured by size exclusion chromatography using low angle laser light scattering (SEC/LALLS) method of Cotts and Ouano. As used herein, the term “molecular weight” refers to weight average molecular weight (Mw). The molecular weight of the polyvinyl acetal resin can in the range of from 50,000 to 1,000,000, from 100,000 to 750,000, or from 250,000 to 750,000 Daltons.

The modified polyvinyl acetal resin may not be cross-linked. That is, in some cases, it may include less than 250, less than 200, less than 150, less than 100, less than 50, less than 25, less than 10, less than 5, less than 3, less than 2, or less than 1 parts per million (ppm) by weight of a dialdehyde cross linking agent. Additionally, or in the alternative, the modified polyvinyl acetal resin may include less than 2, less than 1, less than 0.5, or less than 0.25 weight percent of an acidic crosslinking agent. In some cases, little or none (e.g., less than 5, less than 2, less than 1, or less than 0.5 phr) of these crosslinking agents may be added to the resin or its precursors during the method of forming the modified polyvinyl acetal resin discussed herein.

The modified polyvinyl acetal resin can have a refractive index of at least 1.480, at least 1.485, at least 1.486, at least 1.490, at least 1.495, at least 1.500, at least 1.505, at least 1.510, at least 1.515, at least 1.520, at least 1.525, at least 1.530, at least 1.535, at least 1.540, at least 1.545, at least 1.550 and/or not more than 1.600, not more than 1.595, not more than 1.590, not more than 1.585, not more than 1.580, not more than 1.575, not more than 1.570, not more than 1.565, not more than 1.560, not more than 1.555, not more than 1.550, not more than 1.545, not more than 1.540, not more than 1.535, not more than 1.530, not more than 1.525, not more than 1.520, not more than 1.515, not more than 1.510, not more than 1.505, not more than 1.500, not more than 1.495, not more than 1.490, or not more than 1.488.

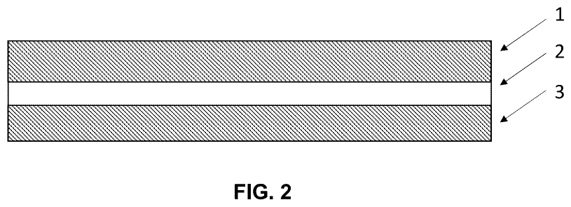

Turning now to FIG. 2, a schematic cross-section of an interlayer according to various embodiments of the present technology is shown. The interlayer illustrated in FIG. 2 is a multiple layer interlayer (multilayer interlayer) having, for example, a first resin layer 1, a second resin layer 2, and a third resin layer 3. As used herein, the terms “first,” “second,” “third,” and the like are used to describe various elements, but such elements should not be unnecessarily limited by these terms. These terms are only used to distinguish one element from another and do not necessarily imply a specific order or even a specific element. For example, an element may be regarded as a “first” element in the description and a “second” element in the claims without being inconsistent. Consistency is maintained within the description and for each independent claim, but such nomenclature is not necessarily intended to be consistent therebetween. In some cases, the interlayer may include four or more layers (embodiment not shown in FIG. 2).

As shown in FIG. 2, the second resin layer 2 may be located between and adjacent to the first and third resin layers 1, 3. The second resin layer 2 may be referred to as the “core” or “inner” layer and the first and third resin layers 1, 3 may be referred to as the “skin” or “outer” layers. When the interlayer includes more than three layers, the outermost layers may be referred to as the skin layers, while the innermost layer may be referred to as the core layer.

In one or more embodiments, at least one of the resin layers (e.g., skin layers 1 and 3 and/or core layer 2 shown in FIG. 2) can include at least one modified polyvinyl acetal resin as described previously. The modified polyvinyl acetal resin can be present in both the skin and core layers in the same or different amounts, while, in other cases, the modified polyvinyl acetal resin can be present only in the skin or core layer. In some embodiments, the skin layers 1 and 3 may comprise at least 85, at least 90, at least 95, at least 97, or at least 99 weight percent of an unmodified polyvinyl acetal resin, while the core layer 2 may comprise at least 85, at least 90, at least 95, at least 97, or at least 99 weight percent of at least one modified polyvinyl acetal resin comprising residues of a cyclic vinyl monomer. As used herein, the term “unmodified polyvinyl acetal resin,” refers to a polyvinyl acetal resin that does not include residues of a cyclic vinyl acetal monomer and comprises at least 99 weight percent of residues of vinyl acetate, polyvinyl alcohol, and at least one aldehyde.

In some embodiments, at least one of the resin layers of the multilayer interlayer may comprise at least one thermoplastic polymer in addition to the polyvinyl acetal (or modified polyvinyl acetal) resin. Examples of suitable thermoplastic polymers can include, but are not limited to, polyvinyl acetal resins, polyurethanes (PU), poly(ethylene-co-vinylacetate) (EVA), polyvinyl chlorides (PVC), poly(vinylchloride-co-methacrylate), polyethylenes, polyolefins, ethylene acrylate ester copolymers, poly(ethylene-co-butyl acrylate), silicone elastomers, epoxy resins, and acid copolymers such as ethylene/carboxylic acid copolymers and ionomers thereof, derived from any of the previously-listed polymers, and combinations thereof.

In some cases, the core layer 2 and/or skin layers 1,3 may include substantially no resin other than the polyvinyl acetal resin (or modified polyvinyl acetal resin). In some embodiments, at least one of the core and/or skin layers may include a resin other than the polyvinyl acetal resin (or modified polyvinyl acetal resin) in an amount of not more than 20, not more than 15, not more than 10, not more than 5, not more than 4.5, not more than 4, not more than 3.5, not more than 3, not more than 2.5, not more than 2, not more than 1.5, not more than 1, not more than 0.5, not more than 0.1, or not more than 0.05 weight percent, based on the combined weight of all resins, or it can include less than 0.5, less than 0.3, less than 0.25, less than 0.20, less than 0.15, less than 0.10, less than 0.05 or less than 0.01 phr of resins other than the polyvinyl acetal resin or resins (e.g., polyolefins, acrylic resins, and block copolymers, etc.). In some cases, at least one of the layers may include only a single polyvinyl acetal resin, while, in other cases, one or more of the layers may include a blend of two or more polyvinyl acetal resins. One or more of the skin 1,3 and core layers can be a continuous layer that does not include islands or particles of other polymeric material dispersed therein.

The polyvinyl acetal resin (or resin component or modified polyvinyl acetal resin or component) used in one or more layers of the multi-layer interlayer can include residues of any suitable aldehyde and, in some embodiments, can include residues of at least one, or at least two, or three or more C1 to C10 aldehyde, at least one C3 to C8 aldehyde, at least one C3 to C6 aldehyde, or a C4 to C8, or C4 aliphatic aldehyde. Examples of suitable aldehydes can include, but are not limited to, propionaldehyde, n-butyraldehyde, iso-butyraldehyde, 2-methylvaleraldehyde, n-hexyl aldehyde, 2-ethylhexyl aldehyde, n-octyl aldehyde, and combinations thereof. In some embodiments, the polyvinyl acetal resin or resins used in the layer or layers can include at least 20, at least 30, at least 40, at least 50, at least 60, or at least 70 weight percent of residues of at least one C3 to C8 aldehyde, based on the total weight of aldehyde residues of the resin, and/or can include not more than 90, not more than 85, not more than 80, not more than 75, not more than 70, or not more than 65 weight percent of at least one C3 to C8 aldehyde, or in the range of from 20 to 90, from 30 to 80, or from 40 to 70 weight percent of at least one C3 to C8 aldehyde. The C3 to C8 aldehyde may be selected from the group listed above, or it can be selected from the group consisting of n-butyraldehyde, iso-butyraldehyde, 2-ethylhexyl aldehyde, and combinations thereof.

In some embodiments, the polyvinyl acetal resin may be a polyvinyl butyral (PVB) resin or component (or a modified PVB resin or component). In other embodiments, the polyvinyl acetal resin can be a polyvinyl n-butyral resin that mainly comprises residues of n-butyraldehyde, and may, for example, include not more than 50, not more than 40, not more than 30, not more than 20, not more than 10, not more than 5, or not more than 2 weight percent of residues of an aldehyde other than n-butyraldehyde, based on the total weight of all aldehyde residues of the resin.

When the polyvinyl acetal resin present in one or more layers comprises a PVB resin, the molecular weight of the resins can be at least 30,000, at least 50,000, at least 70,000, at least 100,000, at least 250,000, at least 500,000 Daltons and/or not more than 1,000,000, not more than 750,000, not more than 600,000, not more than 550,000, not more than 500,000, not more than 450,000, or not more than 425,000 Daltons, measured as described previously. The molecular weight of the polyvinyl acetal resin can be in the range of from 50,000 to 1,000,000, from 100,000 to 750,000, or from 250,000 to 750,000 Daltons.

At least one polyvinyl acetal resin present in one or more layers of the interlayer (e.g., first and third layers 1, 3 shown in FIG. 2) can have a residual hydroxyl content of at least 16, at least 16.5, at least 17, at least 17.5, at least 18, at least 18.5, at least 19, at least 19.5, at least 20, or at least 20.5 weight percent and/or not more than 30, not more than 29, not more than 28, not more than 27, not more than 26, not more than 25, not more than 24, not more than 23, not more than 22, nor more than 21, not more than 20, or not more than 19.5 weight percent.

Additionally, or in the alternative, at least one polyvinyl acetal resin present in one or more layers (e.g., first and third layers 1, 3 shown in FIG. 2) can have a residual acetate content of at least 0.5, at least 1, at least 1.5, at least 2, at least 5, at least 10, at least 15, or at least 18 weight percent and/or not more than 35, not more than 30, not more than 25, not more than 20, not more than 15, not more than 10, not more than 8, not more than 6, not more than 5, not more than 3, not more than 2.5, or not more than 2 weight percent.

In some cases, one or more of the polyvinyl acetal resins (including the modified polyvinyl acetal resin) can comprise less than 5, less than 3, less than 2, less than 1, less than 0.5, less than 0.1, or less than 0.05 weight percent of residues other than residual hydroxyl, residual acetal and aldehyde (e.g., olefin residues, acrylic residues, butadiene residues, imide residues, etc.). In some cases, at least one polyvinyl acetal resin may include less than 5, less than 4, less than 3, less than 2, less than 1, or less than 0.5 weight percent of residues of any cyclic vinyl monomers as described herein.

According to some embodiments, two or more layers of the multi-layer interlayer can have different compositions. For example, in some embodiments, one or both of the outer skin layers may be formed from at least a first polyvinyl acetal resin or resin component (e.g., an unmodified polyvinyl acetal resin), while the core or inner layer can be formed from at least a second polyvinyl acetal resin or resin component (e.g., a modified polyvinyl acetal resin or component). In some embodiments, at least one polyvinyl acetal resin used to form the first layer can have a residual hydroxyl content and/or residual acetate content that is at least 2, at least 3, at least 4, at least 5, at least 6, or at least 8 weight percent higher or lower than the residual hydroxyl content and/or residual acetate content of at least one second polyvinyl acetal resin used to form the second layer.

In some cases, the difference between the residual hydroxyl content of the polyvinyl acetal resins in two or more of the layers (e.g., first and second and/or second and third) could also be at least 2, at least 5, at least 10, at least 12, at least 15, at least 20, or at least 30 weight percent and/or not more than 30, not more than 25, not more than 20, not more than 15, not more than 10, or not more than 8 weight percent. As used herein, the term “weight percent different” or “the difference . . . is at least . . . weight percent” refers to a difference between two given weight percentages, calculated by subtracting the one number from the other. For example, a polyvinyl acetal resin having a residual hydroxyl content of 12 weight percent has a residual hydroxyl content that is 2 weight percent lower than a polyvinyl acetal resin having a residual hydroxyl content of 14 weight percent (14 weight percent−12 weight percent=2 weight percent). As used herein, the term “different” can refer to a value that is higher than or lower than another value.

In some embodiments, at least one of the polyvinyl acetal resins used to, for example, form two different layers within the interlayer, can have a residual acetate content different than the other. For example, in some embodiments, the difference (or maximum difference) between the residual acetate content of two of the polyvinyl acetal resins (or any of the layers of the interlayer) can be at least 2, at least 3, at least 4, at least 5, at least 8, at least 10 weight percent and/or not more than 15, not more than 13, not more than 10, not more than 8, not more than 6, not more than 4, not more than 2, not more than 1, or not more than 0.5 percent. One of the polyvinyl acetal resins may have a residual acetate content of less than 15, not more than 13, not more than 12, not more than 10, not more than 8, not more than 6, not more than 5, not more than 4, not more than 3, not more than 2, not more than 1, or not more than 0.5 weight percent, measured as described above.

In some embodiments, at least one of the polyvinyl acetal resins used to form layers of the interlayer can have a residual acetate content of at least 5, at least 8, at least 10, at least 12, at least 14, at least 16, at least 18, at least 20, or at least 30 weight percent. The difference in the residual acetate content between the polyvinyl acetal resins used in two or more resin layers can be within the ranges provided above, or the difference can be less than 3, not more than 2, not more than 1, or not more than 0.5 weight percent.

In some embodiments, the difference between the residual acetate content of polyvinyl acetal resins used in two or more layers can be less than 2, not more than 1, not more than 0.5 weight percent and the difference in the residual acetate content between the polyvinyl acetal resins used in two or more layers can be at least 3, at least 5, at least 8, at least 15, at least 20, or at least 30 weight percent. In other embodiments, the difference in the residual acetate content of polyvinyl acetal resins in two or more layers can be less than 3, not more than 2, not more than 1, or not more than 0.5 weight percent and the difference in the residual hydroxyl content of the same polyvinyl acetal resins can be at least 2, at least 5, at least 10, at least 12, at least 15, at least 20, or at least 30 weight percent.

In some embodiments, one or more of the layers can include at least one plasticizer. In some cases, each of the resin layers shown in FIG. 2 can comprise a polyvinyl acetal resin and at least one plasticizer. Depending on the specific composition of layer, one or more plasticizers may be present in an amount of at least 5, at least 10, at least 15, at least 20, at least 25, at least 30, at least 35, at least 40, at least 45, at least 50, at least 55, at least 60, at least 65, or at least 70 parts per hundred parts of resin (phr) and/or not more than 120, not more than 110, not more than 105, not more than 100, not more than 95, not more than 90, not more than 85, not more than 80, not more than 75, not more than 70, not more than 65, not more than 60, not more than 55, not more than 50, not more than 45, not more than 40 phr, or not more than 35 phr, or in the range of from 5 to 120, from 10 to 110, from 20 to 90, or from 25 to 75 phr. These amounts may refer to a single plasticizer, to a blend of plasticizers, or to one plasticizer in a blend of two or more plasticizers.

As used herein, the term “parts per hundred parts of resin” or “phr” refers to the amount of plasticizer present as compared to one hundred parts of resin, on a weight basis. For example, if 30 grams of plasticizer were added to 100 grams of a resin, the plasticizer would be present in an amount of 30 phr. If the layer includes two or more resins, the weight of plasticizer is compared to the combined amount of all resins present to determine the parts per hundred resin. Further, when the plasticizer content of a layer is provided herein, it is provided with reference to the amount of plasticizer in the mix or melt that was used to produce the layer.

Examples of suitable plasticizers can include, but are not limited to, triethylene glycol di-(2-ethylhexanoate) (“3GEH”), triethylene glycol di-(2-ethylbutyrate), triethylene glycol diheptanoate, tetraethylene glycol diheptanoate, tetraethylene glycol di-(2-ethylhexanoate) (“4GEH”), dihexyl adipate, dioctyl adipate, hexyl cyclohexyladipate, diisononyl adipate, heptylnonyl adipate, di(butoxyethyl) adipate, and bis(2-(2-butoxyethoxy)ethyl) adipate, dibutyl sebacate, dioctyl sebacate, and mixtures thereof. The plasticizer may be selected from the group consisting of triethylene glycol di-(2-ethylhexanoate) and tetraethylene glycol di-(2-ethylhexanoate), or the plasticizer can comprise triethylene glycol di-(2-ethylhexanoate).

Additionally, or alternatively, the plasticizer may include one or more of the following plasticizers: dipropylene glycol dibenzoate, tripropylene glycol dibenzoate, polypropylene glycol dibenzoate, isodecyl benzoate, 2-ethylhexyl benzoate, diethylene glycol benzoate, butoxyethyl benzoate, butoxyethoxyethyl benzoate, butoxyethoxyethoxyethyl benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexonate), di-(butoxyethyl) terephthalate, di-(butoxyethoxyethyl) terephthalate, and mixtures thereof.

In some embodiments, at least one layer (e.g., outer layers 1, 3 in FIG. 2) can include at least one plasticizer in an amount of at least 20, at least 25, at least 30, or at least 35 phr and/or not more than 45, not more than 40, or not more than 35 phr. Additionally, or in the alternative, at least one other layer (e.g., core layer 2 in FIG. 2) can include at least one plasticizer in an amount of at least 50, at least 55, at least 60, at least 65, or at least 70 phr and/or not more than 95, not more than 90, not more than 85, not more than 80, or not more than 75 phr.

At least one of the plasticizers used in a layer or the interlayer can have a refractive index of at least 1.435, at least 1.440, at least 1.445, at least 1.450, at least 1.460, at least 1.470, at least 1.475, at least 1.480, at least 1.490, or at least 1.500 and/or not more than 1.530, not more than 1.525, not more than 1.520, not more than 1.515, not more than 1.510, not more than 1.505, not more than 1.500, not more than 1.495, not more than 1.490, or not more than 1.485.

In some cases, at least one resin layer (e.g., the core layer 2 shown in FIG. 2) can have a total plasticizer content in the range of from 20 to 120 phr, 30 to 90 phr, 45 to 85 phr, or 55 to 80 phr. Alternatively, or in addition, at least one resin layer (e.g., the outer layers 1, 3 shown in FIG. 2) can have a total plasticizer content in the range of from 20 to 45 phr or from 30 to 40 phr. The plasticizer content refers to the total amount of plasticizer in the interlayer and can be the amount of one or two or more plasticizers included in the interlayer.

Resins with higher or lower residual hydroxyl contents and/or residual acetate contents may also, when combined with at least one plasticizer, ultimately include different amounts of plasticizer. As a result, layers formed of polyvinyl acetal resins having different compositions may also have different properties within a single interlayer. Although not wishing to be bound by theory, it is assumed that the compatibility of a given plasticizer with a polyvinyl acetal resin can depend, at least in part, on the composition of the polymer, and, in particular, on its residual hydroxyl content. Overall, polyvinyl acetal resins with higher residual hydroxyl contents tend to exhibit a lower compatibility (or capacity) for a given plasticizer as compared to similar resins having a lower residual hydroxyl content. As a result, polyvinyl acetal resins with higher residual hydroxyl contents tend to be less plasticized and exhibit higher stiffness than similar resins having lower residual hydroxyl contents. Conversely, polyvinyl acetal resins having lower residual hydroxyl contents may tend to, when plasticized with a given plasticizer, incorporate higher amounts of plasticizer, which may result in a softer resin layer that exhibits a lower glass transition temperature than a similar resin having a higher residual hydroxyl content. Depending on the specific resin and plasticizer, these trends could be reversed.

The type of plasticizer used in the skin and core layers can be the same or different. In some embodiments, at least one of the plasticizers may also be a blend of two or more plasticizers. Additionally, in some embodiments, the two outer skin layers (e.g., outer layers 1, 3 shown in FIG. 2) can have compositions (including type and/or amount of plasticizer) which are nearly the same as, or identical to, each other, while the core layer may include a different amount of plasticizer.

In some embodiments, the difference in plasticizer content between the two or more of the resin layers can be at least 2, at least 5, at least 8, at least 10, at least 12, or at least 15, at least 20, at least 25, at least 30, or at least 35 phr. In some cases, the resin layer that includes the resin having a lower hydroxyl content can have the higher plasticizer content. In order to control or retain other properties of the resin layer or interlayer, the difference in plasticizer content between two of the layers may be not more than 75, not more than 70, not more than 65, not more than 60, not more than 55, not more than 50, not more than 45, not more than 40, not more than 30, not more than 25, not more than 20, or not more than 17 phr. In other embodiments, the difference in plasticizer content between two of the resin layers can be at least 25, at least 30, at least 35, at least 40, at least 50, at least 60, at least 70 phr, or at least 80 phr. In some embodiments, the outer skin layers (e.g., first and third layers 1, 3) may have a plasticizer content that is lower than the plasticizer content of the inner core layer (e.g., second layer 2).

Glass transition temperature, or Tg, is the temperature that marks the transition from the glass state of the polymer to its rubbery state. At least one of the plasticized resin layers (for example, the core layer 2) can have a glass transition temperature greater than −15, greater than −12, greater than −10, greater than −5, greater than −2, or 0° C. and/or not more than 20, not more than 15, not more than 12, not more than 10, not more than 5, not more than 2, not more than 0, or not more than −1° C. Alternatively, or in addition, at least one of the resin layers (for example at least one skin layer 1 or 3 as shown in FIG. 2) can have a glass transition temperature of at least 20, at least 22, at least 25, at least 27, at least 29, or at least 30° C. and/or not more than 55, not more than 50, not more than 45, not more than 40, not more than 35, or not more than 32° C.

The glass transition temperatures of the layers described herein were determined by dynamic mechanical thermal analysis (DMTA). The DMTA measures the storage (elastic) modulus (G′) in Pascals, loss (viscous) modulus (G″) in Pascals, and the tan delta (G″/G′) of the specimen as a function of temperature at a given oscillation frequency and temperature sweep rate. The glass transition temperature is then determined by the position of the tan delta peak on the temperature scale. Glass transition temperatures provided herein were determined at an oscillation frequency of 1 Hz under shear mode and a temperature sweep rate of 3° C./min.

In some embodiments, particularly when two of the resin layers have resins with different hydroxyl or acetate and/or plasticizer contents, two of the resin layers may have different glass transition temperatures. The difference in the glass transition temperature of two of the layers (such as, for example, one of the outer layers 1,3 and the core layer 2 shown in FIG. 2) can be at least 2, at least 3, at least 5, at least 8, at least 10, at least 12, at least 15, at least 18, at least 20, at least 22, at least 25, at least 30, or at least 35° C. and/or not more than 60, not more than 55, not more than 50, not more than 45, not more than 40, not more than 35, not more than 30, or not more than 25° C.

In some cases, the outer layer or layers of the multi-layer interlayer may have a higher Tg and therefore, may be considered a “stiff” outer layer, while the inner layer of the multi-layer interlayer may have a lower Tg and be considered a “soft” interlayer. In some embodiments, the outer skin layers may have a Tg that is at least 2, at least 5, at least 10, at least 15, at least 20, at least 25, at least 30, or at least 35° C. and/or not more than 100, not more than 90, not more than 75, not more than 70, not more than 65, not more than 60, not more than 55, not more than 50, not more than 45, or not more than 40, not more than 35, not more than 30, not more than 25° C. higher than the Tg of the inner core layer.

In terms of optical properties, one or more of the plasticized resin layers can have a refractive index of at least 1.465, at least 1.470, at least 1.472, at least 1.474, at least 1.475, at least 1.480, at least 1.485, at least 1.490, at least 1.495, at least 1.500, at least 1.505, at least 1.510, at least 1.525 and/or not more than 1.600, not more than 1.590, not more than 1.580, not more than 1.570, not more than 1.560, not more than 1.550, not more than 1.540, not more than 1.530, not more than 1.520, not more than 1.510, not more than 1.500, not more than 1.490, not more than 1.482, not more than 1.480, or not more than 1.479.

Two or more layers in the interlayer can have different refractive indices, based on the specific compositions of each layer. For example, the type and amount of plasticizer, as well as the particular polyvinyl acetal resin present in each layer. In some cases, the difference in refractive index between two of the layers in the interlayer (e.g., the skin and core layers) can be at least 0.0001, at least 0.005, at least 0.0010 and/or not more than 0.0100, not more than 0.0075, not more than 0.0050, or not more than 0.0025, even when one layer (e.g., core layer 2) includes a modified polyvinyl acetal resin and another layer (e.g., one or more skin layers 1,3) include an unmodified polyvinyl acetal resin, or do not include any modified polyvinyl acetal resins.

In some cases, at least one layer (e.g., first and/or third resin layer 1,3) can have a refractive index of at least 1.470, at least 1.472, at least 1.474 and/or not more than 1.482, not more than 1.480, or not more than 1.479, while at least one of the other layers (e.g., second resin layer 2) may have a refractive index of at least 1.465, at least 1.470, at least 1.475, at least 1.480, at least 1.485, at least 1.490, at least 1.495, at least 1.500, at least 1.505, at least 1.510, or at least 1.525 and/or not more than 1.600, not more than 1.590, not more than 1.580, not more than 1.570, not more than 1.560, not more than 1.550, not more than 1.540, not more than 1.530, not more than 1.520, not more than 1.510, not more than 1.500, or not more than 1.490.

In some embodiments, the interlayer as a whole can have a refractive index of at least 1.480, at least 1.482, at least 1.485, at least 1.487, at least 1.490, at least 1.500, at least 1.510, at least 1.520, at least 1.525 and/or not more than 1.700, not more than 1.675, not more than 1.650, not more than 1.625, not more than 1.600, not more than 1.575, not more than 1.550, not more than 1.525, not more than 1.500, not more than 1.495, not more than 1.490, or not more than 1.485.

Additionally, one or more of the layers of the multi-layer interlayer may include at least one type of additive that can impart particular properties or features to the polymer layer or interlayer. Such additives can include, but are not limited to, dyes, pigments, stabilizers such as ultraviolet stabilizers, antioxidants, anti-blocking agents, flame retardants, IR absorbers or blockers such as indium tin oxide, antimony tin oxide, lanthanum hexaboride (LaB6) and cesium tungsten oxide, processing aides, flow enhancing additives, lubricants, impact modifiers, nucleating agents, thermal stabilizers, UV absorbers, dispersants, surfactants, chelating agents, coupling agents, adhesives, primers, reinforcement additives, fillers, and adhesion control agents (ACAs). Specific types and amounts of such additives may be selected based on the final properties or end use of a particular interlayer and may be employed to the extent that the additive or additives do not adversely affect the final properties of the interlayer or windshield utilizing the interlayer as configured for a particular application.

In some cases, one or more resin layers (or the entire interlayer) may not include a solid refractive index (RI) additive. As used herein, the term “solid RI additive” refers to an additive used to adjust the refractive index of a poly(vinyl acetal) resin, resin layer, or interlayer and which is solid at ambient conditions of 25° C. and 1 atm. One or more or all of the resin layers in an interlayer may include less 0.5, less than 0.25, or less than 0.10 phr. Examples of solid RI additives include, but are not limited to, polyadipates, polystyrene having a molecular weight of less than 2500, epoxides, phthalic acid esters, benzoic acid esters, inorganic oxides such as, for example, zirconium oxide, halogenated additives, and silicon-containing additives, and combinations thereof.

In some embodiments, one or both of the outer skin layers may include a gradient color band near one or both of the edges of the interlayer. Such gradient color bands may be imbedded in all or a portion of the outer skin layer or layers of the interlayer and can have a thickness between 0.025 and 0.375 mm, 0.125 and 0.325 mm, or 0.225 and 0.300 mm. The thickness of the outer skin layer on one of both sides of the interlayer can be from 0.0125 to 0.075 mm, 0.025 to 0.05 mm, or 0.03 to 0.04 mm. As used herein, the term “outer skin layer” includes the gradient color band when present.

According to some embodiments, at least one of the surfaces of the layers or interlayer may be textured in order to facilitate formation of the interlayer or glazing. For example, at least a portion of at least one of the surfaces of one or more of the layers or interlayer may have a surface roughness (Rz) of at least 5, at least 10, at least 15, at least 20, at least 25, at least 30, at least 35, at least 40, at least 45, or at least 50 microns and/or not more than 150, not more than 140, not more than 130, not more than 120, not more than 110, not more than 100, not more than 90, not more than 80, not more than 75, not more than 70, not more than 65, not more than 60 microns, or not more than 40 microns.

As used herein, Rz is a measure of the surface topography of the polymer layer and is an indication of the divergence of the surface from a plane. Additionally, the surface roughness of a layer may also be described by its Rsm, which is a measure of the distance between peaks in the topography of the surface of a polymer layer. Further description on how to determine Rz and Rsm are provided in U.S. Pat. No. 7,883,761, the entirety of which is incorporated herein by reference to the extent not inconsistent with the present disclosure. Such roughness can be achieved by any suitable method including, but not limited to, embossing, melt fracturing, and combinations thereof.

The interlayer can have any suitably shaped profile including, for example, a flat profile with generally uniform thickness or a wedged shaped profile with a constant or variable change in thickness. When the interlayer has a flat profile, at least 90, at least 92, at least 95, at least 97, at least 99, or all of the vertical cross-section of the layer or interlayer has a uniform thickness. Such an interlayer may be non-wedged and can have a wedge angle of approximately zero, or less than 0.05 milliradians (mrad).

When the interlayer has a constant thickness profile (as generally shown in FIG. 2), each of its individual layers can be flat, or two or more may have a wedged profile and may be arranged such that the overall profile of the interlayer is flat (embodiment not shown). The overall thickness of a constant thickness profile interlayer can be at least 25, at least 27, or at least 30 mils and/or not more than 37, not more than 35, or not more than 34 mils. Each layer may have an average thickness of at least 1, at least 2, at least 3, at least 5, or at least 6 mils and/or not more than 20, not more than 15, not more than 10, not more than 8, or not more than 6 mils, with the core layer having a thickness from 1 to 8 mils or 2 to 6 mils and the skin layers having each having a thickness of 1 to 15 mils, or 2 to 12 mils. As used herein, the term “average thickness” refers to the thickness of the layer or interlayer, measured at 10 evenly spaced locations across the entire vertical height of the interlayer and then averaged (i.e., divided by 10).

In some cases, the resin used to form the skin layers may comprise 50 to 95 weight percent or 85 to 92 weight percent of the total interlayer, while the resin used to form the core layer may comprise from 5 to 50 or from 8 to 15 weight percent of the total interlayer.

In some embodiments, the interlayer may have an overall wedged or wedge-shaped profile. As used herein, the term “wedge-shaped” or “wedged” means having a cross-sectional geometry at least a portion of which increases from a relatively thin dimension to a relatively thicker dimension. In some cases, the thickness of the thinnest edge of the wedged portion of the interlayer (e.g., the tapered zone) can be at least 0.50, at least 0.55, at least 0.60, at least 0.65, or at least 0.70 mm and/or not more than 1.1, not more than 1.0, not more than 0.95, not more than 0.90, not more than 0.85, not more than 0.80, not more than 0.75, or not more than 0.70 mm, and the thickness of the thickest edge of the wedge portion of the wedged portion of the interlayer can be at least 0.60, at least 0.65, at least 0.70, at least 0.75, at least 0.80, at least 0.85, or at least 0.90 mm and/or not more than 2.0, not more than 1.95, not more than 1.90, not more than 1.85, not more than 1.80, not more than 1.75, not more than 1.70, not more than 1.65, not more than 1.60, not more than 1.55, or not more than 1.50 mm. The thickness of the overall interlayer at any point is the combined thickness of all its layers at that point.

When at least one layer of the interlayer (or the interlayer itself) is wedged, at least a portion of the interlayer can have at least one wedge angle of at least 0.05, at least 0.10, at least 0.13, at least 0.15, at least 0.20, at least 0.25, at least 0.30, at least 0.35, or at least 0.40 milliradians (mrad) and/or not more than 1.0, not more than 0.90, not more than 0.85, not more than 0.80, not more than 0.75, not more than 0.70, not more than 0.65, or not more than 0.60 mrad. In some embodiments, the interlayer can have an overall wedge angle of at least 0.3, at least 0.35, at least 0.40, at least 0.45, at least 0.50, at least 0.55, at least 0.60, at least 0.65, at least 0.70, at least 0.75 mrad and/or not more than 0.80, not more than 0.75, not more than 0.70, not more than 0.65, not more than 0.60, not more than 0.55, not more than 0.50, not more than 0.45, not more than 0.40, not more than 0.35, not more than 0.30 mrad.

In some embodiments, when the interlayer is a multilayer interlayer, one or more of the skin or core layers may be wedge-shaped. In some cases, only the outer skin layers may be wedge-shaped, while the inner core layer may be flat or substantially flat. In other cases, one of the skin layers may be wedge-shaped, while the other may be flat. In some cases, both of the outermost skin layers and the innermost core layer may be wedge-shaped with the similar or different wedge angles. In another case, the outer layers may be flat, while the inner core layer is wedged. In other cases, the outer skin layers may be wedge-shaped, while the inner core layer may be wedge-shaped or flat.

When the interlayer is a wedge-shaped interlayer, it can have at least one constant wedge angle that does not change over all or a portion of the interlayer, while, in other cases, the wedge angle can vary continuously throughout all or a portion of the region of non-uniform thickness. Specific embodiments of interlayers having different tapered zone configurations are described in detail in U.S. Patent Application Publication No. 2017/0285339, the entirety of which is incorporated herein by reference to the extent not inconsistent with the present disclosure.

Whether the interlayer has a flat or wedged profile, the outer skin layers (shown as layers 1 and 3 in FIG. 2) may have similar or different thicknesses. When the outer layers have similar thicknesses, the maximum difference between the thicknesses of the two outer layers can be no more than 5, not more than 3, not more than 2, not more than 1, or not more than 0.5 percent. In some cases, the two outer skin layers may have the same nominal thickness.

In other embodiments, at least a portion of one outer skin layer 1 or 3 may be thicker than at least a portion of the other outer skin layer 3 or 1. For example, in some embodiments, one of the outer skin layers 1, 3 may be at least 5, at least 10, at least 15, at least 20, at least 25, at least 30, at least 35, at least 40, at least 45, or at least 50 percent thicker than the other outer skin layer at one or more locations on the interlayer. Alternatively, or in addition, at least a portion of one outer skin layer 1 or 3 may be not more than 90, not more than 85, not more than 80, not more than 75, not more than 70, not more than 65, not more than 60, not more than 55, not more than 50, or not more than 45 percent thicker than the other outer skin layer 3 or 1 at one or more locations along the interlayer.

Interlayers as described herein may be formed by any suitable method. For example, in some embodiments, the multilayer interlayer may be formed by co-extrusion. In such a process, at least three streams of resin, including a first outer skin resin stream, a second outer skin resin stream, and an inner core resin stream located between the first and second outer skin resin streams may be extruded out of a die simultaneously to form the co-extruded resin sheet. In other embodiments, the multi-layer interlayer may be formed by separately extruding each of the first outer skin, second outer skin, and core layer resin streams to form three separate layers, then laminating the layers to one another to form the multi-layer interlayer. In some cases, both co-extrusion and lamination may be used to form the multiple layer interlayer. In some cases, co-extrusion may be used to form a multiple layer sheet having, for example, at least 2, at least 3, or 4 or more layers. Then, the sheet may be laminated to another sheet including 1 or more other layers to form the multiple layer interlayer. In some cases, one or more layers of the sheets may be flat, while one or more layers of the sheets may be wedge shaped. In some embodiments, the multi-layer sheet may have a flat profile and may be laminated to a single layer sheet having a wedged profile to provide a wedge-shaped multi-layer interlayer.

Interlayers configured and formed according to embodiments of the present technology may exhibit enhanced optical and/or acoustic properties as compared to interlayers formed from conventional polymeric layers. For example, in some embodiments, the interlayer may have a mottle value of not more than 3.5, not more than 3.25, not more than 3, not more than 2.75, not more than 2.5, not more than 2.25, not more than 2, not more than 1.75, not more than 1.5, or not more than 1. Mottle is measure of optical quality, which is detected as a texture or graininess. When mottle is too high or too severe, it results in an objectionable visual appearance in the interlayer or glazing.

The mottle values provided herein were determined using a Clear Mottle Analyzer (CMA) that includes a xenon arc lamp, a sample holder, a projection screen, and a digital camera. The xenon arc lamp is used to project a shadowgraph of a laminated sample onto the screen and the camera is configured to capture an image of the resulting shadowgraph. The image is then digitally analyzed using computer imaging software and compared to images of previously-captured standard samples to determine the mottle of the sample. A method of measuring mottle using a CMA is described in detail in U.S. Pat. No. 9,311,699.

Clarity is another optical parameter used to describe the performance of the interlayers described herein and may be determined by measuring haze value or percent. Haze value represents the quantification of light scattered by a sample in contrast to the incident light. In some embodiments, the resin blends, layers, and interlayers described herein may have a haze value of less than 5 percent, less than 4 percent, less than 3 percent, less than 2 percent, less than 1, or less than 0.5 percent, as measured in accordance with ASTM D1003-13—Procedure B using Illuminant C, at an observer angle of 2 degrees. The test is performed with a spectrophotometer, such as a Hunterlab UltraScan XE instrument (commercially available from Hunter Associates, Reston, Va.), on a polymer sample having a thickness of 0.76 mm, which has been laminated between two sheets of clear glass each having a thickness of 2.3 mm (commercially available from Pittsburgh Glass Works of Pennsylvania).

In some embodiments, the interlayer may have a visual transmittance (% TvisK) of at least 65, at least 70, at least 75, at least 80, at least 81, at least 82, at least 83, at least 84, at least 85, at least 85.5, at least 86, at least 86.5, at least 87, at least 87.5, at least 88, or at least 88.5 percent. Additionally or alternatively, the interlayer can have a total solar transmittance (% Tts) of not more than 75, not more than 70, not more than 65, not more than 60, not more than 55, not more than 50, or not more than 45%, measured according to ISO 13837.

Interlayers as described herein may also exhibit desirable acoustic performance. For example, in some embodiments, the interlayer according to embodiments of the present technology may have a tan delta value of at least 0.70. Tan delta is the ratio of the loss modulus (G″) in Pascals to the storage modulus (G′) in Pascals of a specimen measured by Dynamic Mechanical Thermal Analysis (DMTA). The DMTA is performed with an oscillation frequency of 1 Hz under shear mode and a temperature sweep rate of 3° C./min. The peak value of the G″/G′ curve at the glass transition temperature is the tan delta value. The tan delta of the interlayers described herein may be at least 1.0, at least 1.05, at least 1.10, at least 1.25, at least 1.50, at least 1.75, at least 2.0, or at least 2.25 and/or not more than 5, not more than 4.75, not more than 4.5, not more than 4.25, not more than 4, not more than 3.75, not more than 3.5, not more than 3.25, not more than 3, or not more than 2.5.

Additionally, the interlayers can have a damping loss factor, or loss factor, of at least 0.10, at least 0.15, at least 0.17, at least 0.20, at least 0.25, at least 0.27, at least 0.30, at least 0.33, or at least 0.35. Loss factor is measured by Mechanical Impedance Measurement as described in ISO Standard 16940. A polymer sample is laminated between two sheets of clear glass, each having a thickness of 2.3 mm, and is prepared to have a width of 25 mm and a length of 300 mm. The laminated sample is then excited at the center point using a vibration shaker, commercially available from Brüel and Kjær (Nærum, Netherlands) and an impedance head (Brüel and Kjær) is used to measure the force required to excite the bar to vibrate and the velocity of the vibration. The resultant transfer function is recorded on a National Instrument data acquisition and analysis system and the loss factor at the first vibration mode is calculated using the half power method.

According to embodiments of the present technology, interlayers having at least one resin layer comprising the modified polyvinyl acetal resin described herein may be more easily recycled and/or recycled in larger quantities than similar interlayers that do not include the modified polyvinyl acetal. For example, in some cases, a multiple layer interlayer including at least a pair of outer skin layers and an inner core layer including the modified polyvinyl acetal resin can be more easily recycled than a similar multilayer interlayer having identical skin layers and a core layer without a modified polyvinyl acetal resin.

Recycling of the interlayer can be performed by any known process and, in some cases, results in a blend of two or more polyvinyl acetal resins (e.g., a skin resin and a core resin), typically with at least one plasticizer. In some cases, due to the increased refractive index of the modified polyvinyl acetal resin as compared to a similar, unmodified polyvinyl acetal resin, a greater amount of the modified polyvinyl acetal resin can be recycled than would be expected if the resin were unmodified, and the recycled composition can still maintain desirable properties, including optical properties. The recycled interlayer can include post-consumer scrap, post-industrial scrap, and/or pre-consumer scrap.

For example, in some cases, a recycled blended composition can include at least one polyvinyl acetal resin and at least one modified polyvinyl acetal resin as described herein. The two resins can have different hydroxyl contents within one or more of the ranges herein, and as a result, may have different plasticizer contents and/or refractive indices. The modified polyvinyl acetal resin can be present in the blended composition in an amount of at least 1.2, at least 1.5, at least 2, at least 5, at least 10, at least 12, or at least 15 weight percent and/or not more than 30, not more than 25, not more than 20, not more than 17, not more than 15, or not more than 10 weight percent, based on the total weight of resins in the composition.

In some cases, the total amount of modified polyvinyl acetal resin composition (e.g., plasticized polyvinyl acetal resin as described herein) can be present in the blended composition in an amount of at least 1, at least 2, at least 5, at least 10, at least 12, or at least 15 weight percent and/or not more than 50, not more than 45, not more than 40, not more than 35, not more than 30, not more than 25, not more than 20, or not more than 15 weight percent, based on the total weight of the blended composition (e.g., resins and plasticizer). Even with higher amounts of a different polyvinyl acetal resin, the blended composition can still exhibit a haze of less than 2, less than 1.5, or less than 1.

In some cases, at least a portion of the blended composition may be used to form a recycled content interlayer. Such interlayers may include, for example, at least 1, at least 5, at least 10, at least 15, at least 20, or at least 25 percent and/or not more than 75, not more than 70, not more than 65, not more than 60, not more than 55, not more than 50, or not more than 45 percent of recycled content material, based on the total weight of the interlayer. In some cases, at least a portion of the outer skin layers of the recycled content interlayer may include the recycled content resin (including, for example, a recycled content modified PVB resin) and at least one plasticizer and can have one or more of the properties discussed herein. The interlayer may be a multilayer interlayer and the other layers may or may not include recycled content resin.

Interlayers as described herein may be used to form a glazing. Glazings (or laminates or panels) may be formed by sandwiching an interlayer according to embodiments of the present technology between a first and second rigid substrate and laminating the construct to form a multi-layer glazing.

Multiple layer glazings or panels as described herein generally comprise a first rigid substrate sheet having a first substrate thickness and a second rigid substrate sheet having a second substrate thickness. Each of the first and second substrates can be formed of a rigid material, such as glass, and may be formed from the same, or from different, materials. In some embodiments, at least one of the first and second substrates can be a glass substrate, while, in other embodiments, at least one of the first and second can be formed of another material including, for example, a rigid polymer such as polycarbonate, copolyesters, acrylic, polyethylene terephthalate, and combinations thereof. In embodiments, both rigid substrates are glass. Any suitable type of non-glass material may be used to form such a substrate, depending on the required performance and properties.

Any suitable type of glass may be used to form the rigid glass substrate, and, in some embodiments, the glass may be selected from the group consisting of alumina-silicate glass, borosilicate glass, quartz or fused silica glass, and soda lime glass. The glass substrate, when used, may be annealed, thermally-strengthened or tempered, chemically-tempered, etched, coated, or strengthened by ion exchange, or it may have been subjected to one or more of these treatments. The glass itself may be rolled glass, float glass, or plate glass. In some embodiments, the glass may not be chemically-treated or strengthened by ion exchange, while, in other embodiments, the glass may not be an alumina-silicate glass. When the first and second substrates are glass substrates, the type of glass used to form each substrate may be the same or different.

The rigid substrates can have any suitable thickness. In some embodiments, when the rigid substrates are all glass substrates, the nominal thickness of at least one of the glass sheets (first or second glass) ranges from 0.1 mm to 12.7 mm and the multiple layer glass panels include the configurations of any combinations of the first and second glass sheets (and any other glass or rigid sheets, if desired). In some embodiments, the nominal thickness of the first and/or second substrates can be at least 0.4, at least 0.5, at least 0.7, at least 0.75, at least 1.0, at least 1.25, at least 1.3, at least 1.6, at least 1.9, at least 2.2, at least 2.5, or at least 2.8 and/or less than 3.2, less than 2.9, less than 2.6, less than 2.5, less than 2.3, less than 2.0, less than 1.75, less than 1.7, less than 1.5, less than 1.4, or less than 1.1 mm.

Additionally, or in the alternative, the first and/or second substrates can have a nominal thickness of at least 2.3, at least 2.6, at least 2.9, at least 3.2, at least 3.5, at least 3.8, or at least 4.1 and/or less than 12.7, less than 12.0, less than 11.5, less than 10.5, less than 10.0, less than 9.5, less than 9.0, less than 8.5, less than 8.0, less than 7.5, less than 7.0, less than 6.5, less than 6.0, less than 5.5, less than 5.0, or less than 4.5 mm. Other thicknesses may be appropriate depending on the application and properties required.

When multiple layer panels include two substrates having the same nominal thickness such panels may be referred to as “symmetric configurations,” because the ratio of the nominal thickness of one substrate to the nominal thickness of the other substrate equals 1. When multiple layer panels include two substrates having different nominal thicknesses such panels may be referred to as “asymmetric configurations,” because the ratio of the nominal thickness of one substrate to the nominal thickness of the other substrate does not equal 1. In some cases, the thicker rigid substrate or panel can have a nominal thickness that is at least 1.05, at least 1.5, at least 2, at least 2.5, at least 3, or at least 5 times thicker and/or not more than 10, not more than 8, not more than 6, not more than 5, not more than 3, not more than 2, or not more than 1.5 times thicker than the nominal thickness of the thinner rigid substrate or panel.

In some embodiments, one or both of the substrates may be wedged. When one or both of the rigid substrates are wedged substrates, the substrate may define a wedge angle of at least 0.05, at least 0.10, at least 0.15, at least 0.20, at least 0.25, at least 0.30, or at least 0.35 milliradians and/or not more than 1, not more than 0.95, not more than 0.90, not more than 0.85, not more than 0.80, not more than 0.75, not more than 0.70, not more than 0.65, not more than 0.60, not more than 0.55 milliradians. When both of the substrates are wedge-shaped, the substrates can have substantially similar wedge angles within 0.001, within 0.005, or within 0.01 milliradians of one another. Alternatively, one of the wedged substrates may have a different wedge angle than the other when both are wedged.

Examples of suitable types of multi-layer panels can include windows for automotive applications including, but not limited to, windshields, side windows, and sunroofs. Examples of suitable types of multi-layer panels for architectural applications include, but are not limited to, windows, laminated glass panels for doors, walls, ceilings, and walkways, and the like.

### EXAMPLES

### Example 1—High Refractive Index Poly(Vinyl Acetal) Resins

Several poly(vinyl acetal) resins, referred to as comparative or control resins CR1 to CR6 in Table 1 below, were prepared by acetalizing polyvinyl alcohol with one or more aldehydes including n-butyraldehyde (n-ButCHO; RI=1.377), and benzaldehyde (BzCHO; RI=1.545). Benzaldehyde was used as a control aromatic monomer for polyvinyl acetals to represent low reactivity of benzaldehyde with polyvinyl alcohols due to its fully conjugated structure. Alkyl, aryl or halogen substitution on the aromatic ring of benzaldehyde may improve its reactivity with polyvinyl alcohol.

Additionally, several poly(vinyl acetal) resins according to embodiments of the present invention were also synthesized. Inventive resins referred to as IR1 through IR5 in Table 1 were prepared by acetalizing polyvinyl alcohol with mixture of n-butyraldehyde and various high refractive index aldehydes, including 4-methylbenzaldehyde (4-MBzCHO, RI=1.545), cinnamaldehyde (CCHO, RI=1.620), 2-hydroxy-1-naphthaldehye (2-Hy-1-NCHO, RI=1.652).

TABLE 1
Different cyclic aldehydes used for inventive resins and
benzaldehyde and n-butyraldehyde for comparative resins.

| | | Wt. % of |
|---|---|---|
| | | Aromatic |
| | | monomer |
| Example | Aromatic monomer | (Feed) |
| 1 | n-butyraldehyde (CR1) (aliphatic) | 0.00 |
| 2 | Benzaldehyde (CR2) | 5.65 |
| 3 | Benzaldehyde (CR3) | 5.65 |
| 4 | Benzaldehyde (CR4) | 4.24 |
| 5 | Benzaldehyde (CR5) | 8.48 |
| 6 | Benzaldehyde (CR6) | 30.25 |
| 7 | Cinnamaldehyde (IR1) | 2.83 |
| 8 | p-tolualdehyde (IR2) | 29.46 |
| 9 | 2-hydroxy-1-naphthaldehyde (IR3) | 29.46 |
| 10 | p-tolualdehyde (IR4) | 35.00 |
| 11 | p-tolualdehyde (IR5) | 38.10 |

### Example 2—Synthesis of Polyvinyl Acetals with Cyclic Aldehydes

Poly(vinyl acetal) s were synthesized in a jacketed 2 L kettle reactor equipped with an overhead stirrer, condenser, addition funnel and temperature probe for temperature monitoring. 115 g of polyvinyl alcohol (99% hydrolyzed) were dissolved in 1323 g water by stirring at 150 rpm and 90° C. for 1 h, resulting in a clear solution. The reaction mixture is cooled to 8° C. after polyvinyl alcohol dissolution. 149.5 g of n-butyraldehyde were then added through addition funnel over 1 min. and stirred at 8° C. and 150 rpm for 30 min.

Concentrated mineral acid catalyst solution (24.058 g concentrated mineral acid catalyst+24.058 g DI water) was quickly added through an addition funnel over about 2 min and the reaction mixture was stirred at 750 rpm for 15 minutes at 8° C. until the point at stirrer torque decreased sharply to minimum (decrease in solution viscosity). After 15 min of additional stirring, the bath temperature was then set to 70-80° C. to heat the reaction mixture for an additional 2-2.25 hrs. The reaction mixture was cooled to room temperature, and poly(vinyl acetal) resin was collected by vacuum filtration. The resin was then washed with 1.6 L of deionized water and neutralized to remove residual acid with potassium hydroxide solution by mixing the solid resin with DI water under continuous agitation and adding KOH solution dropwise to pH 7-7.4. Once the resin was neutralized, it was collected by vacuum filtration and dried in vacuum oven overnight at 55° C., and the dried resin was subsequently ground to 1 mm particle size using ZM 200 Ultra Centrifugal Mill, Retsch®.

Poly(vinyl acetal) resins using mixtures of aliphatic aldehyde with aromatic aldehyde were similarly prepared as per Table 2 for CR2 to CR6 and IR1 to IR5 resins.

TABLE 2
Weight composition of aliphatic aldehyde and
cyclic aldehydes for polyvinyl acetal resins.

| | | Aliphatic | | Aromatic |
|---|---|---|---|---|
| | | aldehyde | | aldehyde |
| | Aliphatic | charged | Aromatic | charged |
| Example | aldehyde | (grams) | aldehyde | (grams) |
| 1 | n-butyraldehyde | 149.50 | n-butyraldehyde | 0.00 |
| | | | (CR1) (aliphatic) | |
| 2 | n-butyraldehyde | 134.55 | Benzaldehyde | 14.95 |
| | | | (CR2) | |
| 3 | n-butyraldehyde | 134.55 | Benzaldehyde | 14.95 |
| | | | (CR3) | |
| 4 | n-butyraldehyde | 138.29 | Benzaldehyde | 11.21 |
| | | | (CR4) | |
| 5 | n-butyraldehyde | 127.08 | Benzaldehyde | 22.43 |
| | | | (CR5) | |
| 6 | n-butyraldehyde | 69.50 | Benzaldehyde | 80.00 |
| | | | (CR6) | |
| 7 | n-butyraldehyde | 142.03 | Cinnamaldehyde | 7.48 |
| | | | (IR1) | |
| 8 | n-butyraldehyde | 82.50 | p-tolualdehyde | 42.00 |
| | | | (IR2) | |
| 9 | n-butyraldehyde | 82.50 | 2-hydroxy-1- | 82.50 |
| | | | naphtha (IR3) | |
| 10 | n-butyraldehyde | 72.80 | p-tolualdehyde | 109.20 |
| | | | (IR4) | |
| 11 | n-butyraldehyde | 72.80 | p-tolualdehyde | 125.00 |
| | | | (IR5) | |

### Example 3—Characterization of Polyvinyl Acetal Resins

The composition of the resulting resin was measured using 1H-NMR quantitative analysis. Samples were prepared by dissolving 20-30 mgs of PVB in 1 mL of deuterated DMSO. 100 μL of a 1,4-dimethoxybenzene solution (DMB, 19.6 mgs per 3 mL of DMSO-d6) was then added to use as chemical shift reference. The samples were heated at 80° C. and stirred until fully dissolved. Samples were then transferred to an NMR tube while hot to run on a Bruker Avance III 600 MHz instrument. (64 scans, 20 s delay time, 80° C. temperature). Samples were analyzed by 600 MHz BBFO probe by 1H-NMR spectroscopy. The amount of aliphatic and aromatic polyvinyl acetal in the resins were determined by comparing the integrals of signals at 0.5 ppm to 7.5 ppm.

Thermal properties of the resulted resins were determined by differential scanning calorimetry by scanning from −55° C. to 250° C. at a scan rate of 10° C./min (ASTM D3418-21). The instrument used is TA Instruments Q2000 DSC with RCS chiller unit. Standard Aluminum pan and non-hermetic lid was used. Sample amount was 3-7 mg. The preliminary thermal cycle by heating the sample at a rate of 10° C./min from −55° C. to 255° C. to erase previous thermal history was performed and recorded. The temperature was held for 2 min. (See Note 6. ASTM D3418-21). Sample was quench cooled to at least −55° C. below the transition temperature of interest. The temperature was held for 0.5 min. The heating at a rate of 10° C./min was repeated, and the heating curve was recorded until all desired transitions have been completed. Tg was determined by the midpoint of the change in baseline heat flow as a function of temperature in second heating cycle.

Weight average molecular weight (kg/mol) of PVB resins was measured by gel permeation chromatography (GPC) in hexafluoroisopropanol (HFIP solvent) with 20 mM potassium trifluoroacetate at 40° C. (flow rate: 1.0 ml/min; sample solution: 20 mg sample in 10 ml of hexafluoroisopropanol with 20 mM of potassium trifluoroacetate+10 μl isopropanol flow rate marker; injection volume: 10 μl; column set: Polymer Laboratories 5 μm HFIP gel guard and Mixed HFIP gel).

The following information provides more details for detection and instrumentation:
Detection
Refractive index set to 40° C.
Peak width settings>0.2 minute (4 S response time) (2.28 Hz)
Attenuation 31250nRIU
Zero Offset 5%
Calibrants: monodisperse polymethylmethacrylate standards, MW=580 to 3,000,000 g/mol
Instrumentation:
Autosampler: Agilent series 1100 Autosampler
Column Oven: Agilent series 1100 Column Oven
Pump: Agilent series 1100 Isocratic Pump
Detector: Agilent series Refractive Index

The refractive index of polyvinyl acetal resin films containing 75 parts per hundred plasticizer were measured. Plasticized resin films were prepared by weighing 20 g of resin and 15 g of TEG-EH (Triethylene Glycol Bis (2-Ethylhexanoate)) plasticizer in a plastic cup. The resin and plasticizer were mixed well and then the mixture was compounded in a Brabender Mixer at 170° C. for 7 min at 50 rpm. The resin and plasticizer compound were then pressed in 30 mil thick film using a hydraulic or pneumatic press. The press temperature was set to 180° C. A PET film (5 mil) was placed on the first metal plate and then a 3″×3″ 30 mil shim was placed on top of the PET film. 5 g of the compounded resin and plasticizer mixture was weighed and the compounded resin was spread on the shim. A second piece of PET film was placed over the shim containing the resin/plasticizer compound and then a second metal plate on top of that. This assembly was placed in the press and pressed at 180° C. and 2000 psi for 5 minutes. The press was cooled to about 40-50° C. then the pressure was released, and the assembly was taken out of the press. The resulting 3 inch by 3 inch 30 mil thick pressed film was taken out from the metal shim and cut into 1-2 inch square pieces for RI measurements. For the RI measurements, Metricon Model 2010 Prism Coupler was used. Sample size was 1-2 inch squares preferred or cut them as needed. The samples were then wiped with a Kim wipe and clamped into the instrument via a plunger that pushed the sample flat against the prism. Depending on how rigid or soft the sample was, the pressure of the plunger was adjusted (higher for rigid, lower for flex). Refractive index of poly(vinyl acetal) films was measured at 589.3 nm wavelength. These RI values were then compared to the RI of PVB Skin Resin. Skin resins are polyvinyl butyral resin with 18.5% PVOH used as a top interlayer in trilayer series. The RI of PVB Skin Resin without plasticizer was 1.490 at 589.3 nm and the RI of PVB skin+38 phr plasticizer was 1.483 at 589.3 nm.

The glass transition temperatures of 30 mil thick plasticized PVB films (PVB resin+75 phr plasticizer) were measured by dynamic mechanical thermal analysis (DMTA) with oscillation frequency 1 Hz under shear mode and temperature sweep rate of 3° C./min from −40° C. to 80° C. The DTMA measured tan delta of the samples as a function of temperature at a given oscilation frequency and temperature sweep rate. Peak value of tan delta curves was considered as glass transition temperature.

Analytical results and compositions of comparative and inventive resins are shown in Table 3 below.

TABLE 3
Analytical results and compositions of comparative and inventive polyvinyl acetal resins

| | | | | | | | | | | RI of | |
|---|---|---|---|---|---|---|---|---|---|---|---|
| | | | | | | | | | | plasticized | |
| | | | | | | | | | | film | |
| | | | Wt. % grafted (NMR) | | | | Tg of | MW | Tg of | | Δ (*PVB |
| | | Wt. % of | % | | | | Resin | (wt. | plasticized | | Skin- |
| | | Aromatic | Polyvinyl | | | | by | average | film by | | core) @ |
| | Aromatic | monomer | aromatic | % | % | % | DSC | MW) | DMTA | 589.3 | 589.3 |
| Example | monomer | (Feed) | aldehyde | PVOH | PVB | PVAc | (deg C.) | (kg/mol) | (deg C.) | nm | nm |
| 1 | n- | 0 | 0.00 | 10.9 | 86.52 | 2.58 | 64.65 | 138.1 | −7.09 | 1.470 | 0.014 |
| | butyraldehyde | | | | | | | | | | |
| | (CR1) | | | | | | | | | | |
| | (aliphatic) | | | | | | | | | | |
| 2 | Benzaldehyde | 5.65 | 1.00 | 20.4 | 76 | 2.6 | 67.08 | 145.1 | 0.4 | 1.474 | 0.010 |
| | (CR2) | | | | | | | | | | |
| 3 | Benzaldehyde | 5.65 | 1.4 | 17.1 | 79.4 | 2.2 | 69.3 | 324.6 | −1.13 | 1.471 | 0.012 |
| | (CR3) | | | | | | | | | | |
| 5 | Benzaldehyde | 4.24 | 1.4 | 16.8 | 79.7 | 2.1 | 67.03 | 346.2 | −2.98 | 1.470 | 0.013 |
| | (CR4) | | | | | | | | | | |
| 5 | Benzaldehyde | 8.48 | 3.8 | 15.4 | 78.5 | 2.4 | 70.42 | 301.2 | 2.57 | 1.472 | 0.011 |
| | (CR5) | | | | | | | | | | |
| 6 | Benzaldehyde | 30.25 | 20.0 | 15.2 | 62.2 | 2.1 | 81.46 | 184.58 | 14.32 | 1.480 | 0.003 |
| | (CR6) | | | | | | | | | | |
| 7 | Cinnamaldehyde | 2.83 | 0.9 | 16.9 | 80.0 | 2.2 | 67.67 | 294.4 | −3.17 | 1.459 | 0.025 |
| | (IR1) | | | | | | | | | | |
| 8 | p- | 29.46 | 20.7 | 9.0 | 66.9 | 3.3 | 77.24 | 234.2 | 8.69 | 1.479 | 0.005 |
| | tolualdehyde | | | | | | | | | | |
| | (IR2) | | | | | | | | | | |
| 9 | 2-hydroxy-1- | 29.46 | 3.0 | 15.2 | 79.6 | 2.2 | 62.93 | 260.1 | −10.11 | 1.486 | −0.002 |
| | naphtha | | | | | | | | | | |
| | (IR3) | | | | | | | | | | |
| 10 | p- | 35 | 22 | 11.4 | 64.4 | 2.1 | 80.3 | 226.7 | 4.16 | 1.480 | 0.003 |
| | tolualdehyde | | | | | | | | | | |
| | (IR4) | | | | | | | | | | |
| 11 | p- | 38.1 | 21 | 13.8 | 63.6 | 2.1 | 83.16 | 208.9 | 4.28 | 1.483 | 0.000 |
| | tolualdehyde | | | | | | | | | | |
| | (IR5) | | | | | | | | | | |

Additional films were made by blending skin resin with select resins (CR1, IR2, IR5) from Table 1 (second resin) and plasticizer using the procedure mentioned above. The haze values of the pressed films were then measured by Hunterlab UltraScan Vis instrument from 360-780 nm with illuminant C/2 and total transmission mode type as per ASTM D1003 Section 8 Procedure B. Results are shown in Table 4.

### Method Procedure:

1. Instrument was standardized using air.
2. Air standard was checked to ensure instrument was properly standardized.
3. PVB film was cleaned using a lint free kim wipe to ensure free of fingerprints or other smudges.
4. PVB Film was placed against transmission port and analyzed to obtain haze value.

TABLE 4
Haze measurement of plasticized polyvinyl acetal resin layers

| | | Second | | | |
|---|---|---|---|---|---|
| | Skin resin | resin | Second | Plasticizer | Haze % |
| Example | (wt. %) | (wt. %) | resin | (wt. %) | (C/2) |
| 12 | 71.01 | 1.45 | CR1 | 27.54 | 3.87 |
| 13 | 68.84 | 3.62 | CR1 | 27.54 | 7.00 |
| 14 | 50.53 | 21.92 | CR1 | 27.54 | 14.78 |
| 15 | 71.01 | 1.45 | IR2 | 27.54 | 0.21 |
| 16 | 68.84 | 3.62 | IR2 | 27.54 | 0.29 |
| 17 | 50.53 | 21.92 | IR2 | 27.54 | 0.37 |
| 18 | 71.01 | 1.45 | IR5 | 27.54 | 0.57 |
| 19 | 68.84 | 3.62 | IR5 | 27.54 | 1.43 |
| 20 | 50.53 | 21.92 | IR5 | 27.54 | 1.71 |

Haze value for skin layer with plasticizer (38 phr) and without second resin with n-butyraldehyde was 0.05%.

### CONCLUSIONS

1. Polyvinyl acetals made with aromatic (cyclic) aldehydes showed higher refractive indices at 589.3 nm as compared to aliphatic aldehydes (CR1) resin.

2. Polyvinyl acetals made with aromatic (cyclic) aldehydes increased molecular weight and glass transition temperature of resin.

3. Plasticized polyvinyl acetals made with aromatic (cyclic) aldehydes increased glass transition temperature.

4. Benzaldehyde is used as comparative example of aromatic (cyclic) aldehyde, and it showed poor reactivity with polyvinyl alcohol, investigated by NMR results. This can happen due to its conjugated structure. However, incorporation of benzaldehyde increased the refractive index of polyvinyl acetal resin.

5. Alkyl and aryl substitution on benzaldehyde ring improved reactivity with polyvinyl alcohol. 4-methyl benzaldehyde showed excellent increment in refractive index (DR2, DR4 and DR5). Difference in refractive indices (skin-core) was decreased with inventive resins. (DR2, DR3, DR4 and DR5). However, DR3 cyclic aldehyde showed less reactivity with polyvinyl alcohol.

6. Some of the other cyclic aldehydes that can work in increasing refractive index and decreasing skin-core RI are 4-methoxybenzaldehyde (MeBzCHO, RI=1.578) and p-Phenylbenzaldehyde (P-PhBzCHO, RI=1.5994).

7. Differences in polyvinyl butyral composition between the skin and core layers of multilayer PVB interlayers, multilayer film scrap cannot be re-extruded. When it is, the resulting blended resin composition exhibits high levels of haze, results in a final interlayer product of unacceptable visual quality. As a result, large scale recycling of multilayer interlayer material has not been successfully achieved. Haze value of these interlayers/films can be improved by adding polyvinyl acetal resin with cyclic aldehydes in skin resin.

8. Haze (Table 4) improved significantly with films made by blending skin resin with select resins from second resin with aromatic/cyclic aldehydes (example 15, 16, 17) as compared to films made by blending skin resin with control resins (example 12, 13, 14).

### Definitions

It should be understood that the following is not intended to be an exclusive list of defined terms. Other definitions may be provided in the foregoing description, such as, for example, when accompanying the use of a defined term in context.

As used herein, the term “modified polyvinyl acetal resin” refers to a polyvinyl acetal resin including residues of at least one cyclic aldehyde.

As used herein, the term “polyvinyl acetal resin component” can refer to an individual polyvinyl acetal resin present in a physical blend of two or more resins or to an acetal moiety present on a single polyvinyl acetal resin.

As used herein, the term “polymer backbone” or “backbone” refers to the longest continuous chain of atoms bonded together in a polymeric compound.

As used herein, the term “side group” or “pendant group” refers to a group of two or more atoms bonded together and extending from the backbone of a polymeric compound.

As used herein, the term “substituted” refers to a molecule in which at least one atom or functional groups in the molecule have been replaced by a different atom or functional group to form a new compound.

As used herein, the term “ring” or “cyclic compound” refers to at least three atoms bonded to one another in the form of a ring or cycle.

As used herein, the term “unsaturated” means having at least one C—C double bond.

As used herein, the term “saturated” means having no C—C double bonds.

As used herein, the term “conjugated” means having at least two C—C double bonds separated by one single C—C bond.

As used herein, the term “cyclic vinyl monomer” refers to a monomer including a vinyl group (—CH2═CH—) and at least one ring group.

As used herein, the term “heteroatom” refers to an atom in the ring of a cyclic compound other than carbon.

As used herein, the term “heterocyclic” refers to a ring group including at least two different types of atoms within the ring.

As used herein, the term “5-member ring” refers to a molecule with a ring structure formed by 5 atoms bonded to one another.

As used herein, the term “6-member ring” refers to a molecule with a ring structure formed by 6 atoms bonded to one another.

As used herein, the term “aromatic” refers to a planar unsaturated ring structure

As used herein, the term “derivative” refers to a chemical compound derived from another chemical compound by a chemical modification.

As used herein, the term “polymer backbone” or “backbone” refers to the longest continuous chain of atoms bonded together in a polymeric compound.

As used herein, the term “side group” or “pendant group” refers to a group of two or more atoms bonded together and extending from the backbone of a polymeric compound.

As used herein, the term “refractive index,” refers to the ratio of the speed of light in a vacuum to the speed of light through the material under consideration. It is measured according to ASTM D542 at a wavelength of 589 nm and 25° C. herein, unless otherwise noted.

As used herein, the term “glass transition temperature,” or “Tg” is the temperature that marks the transition from the glass state of the polymer to the rubbery state. The glass transition temperatures described herein are determined by dynamic mechanical thermal analysis (DMTA). The DMTA measures the storage (elastic) modulus (G′) in Pascals, loss (viscous) modulus (G″) in Pascals, and the tan delta (G″/G′) of the specimen as a function of temperature at a given oscillation frequency and temperature sweep rate. The glass transition temperature is then determined by the position of the tan delta peak on the temperature scale. Specific glass transition temperatures provided herein were determined at an oscillation frequency of 1 Hz under shear mode and a temperature sweep rate of 3° C./min, unless otherwise noted.

As used herein, the term “parts per hundred parts of resin” or “phr” refers to the amount of one component (e.g., plasticizer, additive, etc.) present in a composition as compared to one hundred parts of the resin, on a weight basis.

As used herein, the terms “residual hydroxyl content” refers to the amount of hydroxyl groups that remain on a polyvinyl acetal resin after processing is complete. The residual hydroxyl content is expressed in weight percent, based on the weight of the polyvinyl acetal resin, and is measured herein according to ASTM D-1396, unless otherwise noted.

As used herein, the terms “residual acetyl content” refers to the amount of acetyl groups that remain on a polyvinyl acetal resin after processing is complete. The residual acetyl content is expressed in weight percent, based on the weight of the polyvinyl acetal resin, and is measured herein according to ASTM D-1396, unless otherwise noted.

As used herein, the term “residue” or “moiety” refers to a portion of a polymer, typically originating from reaction of one or more monomers.

As used herein, the term “aliphatic” refers to molecules including saturated or unsaturated molecules that do not include any aromatic groups.

As used herein, the term “haze” or “haze value” refers to a value that represents the quantification of light scattered by a sample in contrast to the incident light. Haze is measured in accordance with ASTM D1003-13-Procedure B using Illuminant C, at an observer angle of 2 degrees, unless otherwise noted. The test is performed with a spectrophotometer, such as a Hunterlab UltraScan XE instrument (commercially available from Hunter Associates, Reston, Va.), on a polymer sample having a thickness of 0.76 mm, which has been laminated between two sheets of clear glass each having a thickness of 2.3 mm (commercially available from Pittsburgh Glass Works of Pennsylvania).

As used herein, the term “resin composition” refers to a composition including one or more polymer resins.

As used herein, the term “resin layer” refers to one or more polymer resins, optionally combined with one or more plasticizers, that have been formed into a polymeric sheet.

As used herein, the term “interlayer” refers to a single or multiple layer polymer sheet suitable for use with at least one rigid substrate to form a multiple layer panel.

As used herein, the terms “single-sheet” interlayer and “monolithic” interlayer refer to interlayers formed of one single resin sheet.

As used herein, the terms “multiple layer” and “multilayer” interlayer refer to interlayers having two or more resin sheets coextruded, laminated, or otherwise coupled to one another.

As used herein, the terms “molecular weight” or “MW” refer to weight average molecular weight, measured by size exclusion chromatography using low angle laser light scattering (SEC/LALLS) method of Cotts and Ouano, unless otherwise noted.

As used herein, the term “different” can refer to a value that is higher than or lower than another value and that is calculated by subtracting one value from the other.

As used herein, the term “vertical cross-section,” refers to the cross-section taken between the upper and lower edges of an interlayer when it is arranged as configured as installed when laminated in a windshield or other end use.

As used herein, the terms “Cx” or “Cx hydrocarbon” or “Cx component” refers to a hydrocarbon compound including “x” total carbons per molecule, and encompasses all olefins, paraffins, aromatics, heterocyclic, and isomers having that number of carbon atoms. For example, each of normal, iso, and tert-butane and butene and butadiene molecules would fall under the general description “C4” or “C4 components.”

As used herein, the term “predominantly” means more than 50 percent by weight. For example, a predominantly propane stream, composition, feedstock, or product is a stream, composition, feedstock, or product that contains more than 50 weight percent propane.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the phrase “at least a portion” includes at least a portion and up to and including the entire amount or time period.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “including,” “include,” and “included” have the same open-ended meaning as “comprising,” “comprises,” and “comprise” provided above.

As used herein, the term “recycled content” refers to being or comprising a composition that is directly and/or indirectly derived from recycle material. Recycled content is used generically to refer to both physical recycled content and credit-based recycled content. Recycled content is also used as an adjective to describe material having physical recycled content and/or credit-based recycled content.

As used herein, the term “polyvinyl acetal resin component” can refer to an individual polyvinyl acetal resin present in a physical blend of two or more resins or to an acetal moiety present on a single polyvinyl acetal resin.

As used herein, the term “unmodified polyvinyl acetal resin,” refers to a polyvinyl acetal resin that does not include residues of a cyclic vinyl acetal monomer and comprises at least 99 weight percent of residues of vinyl acetate, polyvinyl alcohol, and at least one aldehyde.

### Claims not Limited to Disclosed Embodiments

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A polyvinyl acetal resin composition comprising:
a polyvinyl acetal resin component comprising residues of at least one cyclic aldehyde having an unsaturated 5-member or 6-member ring group and another polyvinyl acetal resin component comprising residues of at least one C3 to C8 aliphatic aldehyde;
and at least one plasticizer.

2. A method of making a polyvinyl acetal resin component, said method comprising at least one of the following steps (a) and (b):
(a) acetalizing polyvinyl alcohol with at least one C3 to C8 aliphatic aldehyde and at least one cyclic aldehyde to form a modified polyvinyl acetal resin, wherein the cyclic aldehyde comprises (i) an unsaturated 5-member or 6-member ring and/or (ii) a heterocyclic ring; and/or
(b) blending a polyvinyl acetal resin comprising residues of a cyclic aldehyde and/or a heterocyclic ring with another polyvinyl acetal resin comprising at least 50 weight percent of residues of a C3 to C8 aliphatic aldehyde to form a blended polyvinyl acetal resin composition.

3. The composition of claim 1, wherein the cyclic aldehyde includes a saturated ring.

4. The composition of claim 1, wherein the cyclic aldehyde includes an unsaturated ring.

5. The composition of claim 1, wherein the cyclic aldehyde is a heterocyclic aldehyde.

6. The composition of claim 1, wherein the cyclic aldehyde includes a ring having not more than 30 carbon atoms.

7. The composition of claim 1, wherein the cyclic aldehyde includes a ring having only carbon atoms.

8. The composition of claim 1, wherein the cyclic aldehyde includes a conjugated ring.

9. The composition of claim 1, wherein the residues of the cyclic aldehyde are present in the polyvinyl acetal resin in an amount of at least 1 weight percent and/or not more than 50 weight percent, based on the total aldehyde residues of the polyvinyl acetal resin.

10. The composition of claim 1, wherein the refractive index of the cyclic aldehyde or the heterocyclic aldehyde is at least 1.500.

11. (canceled)

12. (canceled)

13. (canceled)

14. The method of claim 2, wherein the first polyvinyl acetal resin comprises at least 0.5 weight percent and/or not more than 35 weight percent of residual acetyl groups.

15. (canceled)

16. The method of claim 2, wherein the plasticizer is selected from the group consisting of triethylene glycol di-(2-ethylhexanoate), triethylene glycol di-(2-ethylbutyrate), triethylene glycol diheptanoate, tetraethylene glycol diheptanoate, tetraethylene glycol di-(2-ethylhexanoate), dihexyl adipate, dioctyl adipate, hexyl cyclohexyladipate, diisononyl adipate, heptylnonyl adipate, di(butoxyethyl) adipate, and bis(2-(2-butoxyethoxy)ethyl) adipate, dibutyl sebacate, dioctyl sebacate, and mixtures thereof.

17. The method of claim 2, wherein the plasticizer is selected from the group consisting of dipropylene glycol dibenzoate, tripropylene glycol dibenzoate, polypropylene glycol dibenzoate, isodecyl benzoate, 2-ethylhexyl benzoate, diethylene glycol benzoate, butoxyethyl benzoate, butoxyethoxyethyl benzoate, butoxyethoxyethoxyethyl benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexonate), di-(butoxyethyl) terephthalate, di-(butoxyethoxyethyl) terephthalate, and mixtures thereof.

18. (canceled)

19. The method of claim 2, wherein the plasticizer is present in the first polyvinyl acetal resin composition or layer in an amount of at least 20 phr and/or not more than 45 phr.

20. The method of claim 2, further comprising a blended polyvinyl acetal resin layer comprising the blended resin composition.
